(19) United States
(12) Patent Application Publication
(10) Pub. No.: US 2012/0313383 A1
(43) Pub. Date: Dec. 13, 2012

(54) Electronic Blocking Unit For Adding To A Manually Operateable Locking Device Of A Door, A Window Or The Like And Locking System

(75) Inventors: Lars Lundberg, Stockholm (SE); Hakan Nordvall, Eskilstuna (SE)

(73) Assignee: Dorma GmbH + Co. KG, Ennepetal (DE)

(21) Appl. No.: 13/475,443

(22) Filed: May 18, 2012

(30) Foreign Application Priority Data
May 19, 2011 (DE) 10 2011 050 492

(51) Int. Cl. E05C 1/12; E05C 1/10

(52) U.S. Cl. 292/144; 292/138; 292/145

(57) ABSTRACT

An electronic blocking unit for adding to a manually operateable locking device in particular a mortise lock, to provide a manually and electronically operateable locking system. The electronic blocking unit includes a blocking element, which is moveable between a blocking position and a non-blocking position, a drive mechanism for moving the blocking element, a control unit for operating the drive mechanism and a power supply for operating the control unit and the drive mechanism. The blocking element is constructed in such a way that in the blocking position it blocks an opening of a door, a window or the like and in the non-blocking position it does not block the opening of the door, the window or the like. A locking system of a door, a window or the like is formed by a manually operateable locking device and an electronic blocking unit.

### BACKGROUND OF THE INVENTION

1. Field of the Invention

The invention relates to an electronic blocking unit that is added to a manually operateable locking device of a door, a window, or the like. The invention further relates to a locking system for a door, a window, or the like, being manually and electronically operateable.

2. Description of the Related Art

Manually operateable locking devices for movable elements like doors, windows or the like are well known. Simple locking devices, in particular mortise locks, are often purely manually operateable. Such locking devices have a latch bolt or a dead bolt, in particular a hook bolt, which projects on the cuff plate side and which can be retracted by a latch mandrel-operated nut. The term “mortise lock” generally refers to locking devices that are designed to be inserted into a door, in particular into a space at the edge of a door. Mortise locks typically have one or more latches or bolts that project from the lock to engage with a strike or some other part of a door frame, window frame, or the like, when the door, the window, or the like is closed. The latches or bolts retain the door or window closed and have to be retracted back into the locking device to allow the door, the window or the like to be opened.

A wide range of different locking devices, in particular mortise locks, are used in the marketplace. Besides, purely manually locking devices motorised locking devices or electromechanical locking devices are known, as well. These locking devices are often operated by an electromagnet actuating a lever which is mounted on one side of the locking device and to which a rotationally mounted bolt is attached. When the electromagnet is energized, the lever is thereby held in its locked and unlocked position.

Purely manually operateable locking devices are restricted in their operational field. Locking devices that can be operated manually and electromechanically are often very complex and expensive.

### SUMMARY OF THE INVENTION

It is an object of the present invention to provide an electronic blocking unit that enables in an easy and inexpensive way to enlarge a purely manually operateable locking device, in particular a mortise lock, into a manually and electromechanically operateable locking system. Further, a locking system is desired that can easily be changed between a purely manually operateable locking device and a manually and electromechanically operateable locking device.

In one embodiment, an electronic blocking unit for adding to a manually operateable locking device of a door, window or the like, in particular a mortise lock, to provides a manually and electromechanically operateable locking system. The electronic blocking unit comprises a blocking element, which is moveable between a blocking position and a non-blocking position. Further, the electronic blocking unit comprises a drive mechanism for moving the blocking element and a control unit for operating the drive mechanism. A power supply is provided for operating the control unit and the drive mechanism. The blocking element is constructed in such a way that in the blocking position it blocks the opening of the door, the window or the like and in the non-blocking position it does not block the opening of the door, the window or the like.

Such an electronic blocking unit enables in an easy and inexpensive way to enlarge a purely manually operateable locking device, in particular a mortise lock, into a manually and electromechanically operateable locking system. The electronic blocking unit is an additional element, a so called add-on for an ordinary manually operateable locking device. That means a standard manually operateable locking device can be modified into a manually and electromechanically operateable locking system by adding the electronic blocking unit.

The electronic blocking unit can be fixed to the manually operateable locking device, in particular to a standard mortise lock, using simple connection elements like screws or the like. For example, a forend connection screw and a barrel nut can be loosened and removed from the manually operateable locking device. After that an upper or lower cover lid can be removed from the locking device and the locking device body, respectively. The electronic blocking unit can be fixed, in particular inserted, to the locking device body at the same position that the cover lid was placed. After fixing the electronic blocking unit into the manually operateable locking device, the forend connection screw and the barrel nut can be reinstalled. In other words, the electronic blocking unit can replace the upper or lower cover lid of a manually operateable locking device. Such an electronic blocking unit enables that an ordinary locking device can be easily enlarged to a locking device which can selectively be operated manually or electromechanically. In particular, the electronic blocking unit enables in an easy way a blocking of the mechanical mechanism of the locking device.

The blocking element of the electronic blocking unit can have different shapes. The blocking element is moveable between a blocking position and a non-blocking position. In the blocking position the blocking element can prevent the opening of the door, the window or the like. In other words, in the blocking position the blocking element blocks the locking device, so that the door, the window or the like cannot be opened. In the non-blocking position the blocking element does not block the opening of the door, the window or the like. To move the blocking element between the blocking position and the non-blocking position a drive mechanism is provided. The drive mechanism enables the movement of the blocking element. Thereby, the drive mechanism can stay in direct contact to the blocking element or in indirect contact to the blocking element. The control unit of the electronic blocking unit operates the drive mechanism. Therefore, the control unit transmits signals to the drive mechanism. A power supply of the electronic blocking unit enables the operation of the control unit and the drive mechanism. The electronic blocking unit can comprise a housing in which some or all of the aforementioned elements can be received.

After adding the electronic blocking unit to the manually operateable locking device, in particular to the housing of the manually operateable locking device, a manifold locking system is created. An advantage of such an electronic blocking unit is that it can be easily removed from the locking system, so that a purely manually operateable locking device can be obtained.

According to a one embodiment of the invention, an electronic blocking unit is provided, wherein the blocking element is constructed in such a way that it blocks the movement of a mechanical cylinder of the locking device. Therefore, the electronic blocking unit is constructed such that the locking element can get, in its blocking position, in contact with the mechanical cylinder of the blocking device. In other words, in the blocking position the blocking element engages into the mechanical cylinder of the locking device and prevents that the cylinder can be moved, in particular rotateably moved. In the blocking position the blocking element can engage the mechanical cylinder of the locking device friction- and/or form-locking. The mechanical cylinder can comprise rotor which can be rotated by a key or a handle. The blocking element can be constructed in such a way that it blocks the movement of the rotor of the mechanical cylinder of the locking device. Therefore, the rotor can comprise a receiving unit, like a recess or a nut, for receiving the blocking element.

Further, an electronic blocking unit is preferred, which is characterised in that the drive mechanism is a motor or a solenoid arrangement. Advantageously, the drive mechanism is a two position linear motor, in particular a step motor, which can move the blocking element between the blocking position and the non-blocking position. The linear motor can have a self-centering tip that is connected to the blocking element wherein the self-centering tip is guided by the linear motor. Alternatively, the drive mechanism can be a solenoid arrangement. The solenoid arrangement is constructed such that it moves the blocking element between the two positions, namely the blocking position and the non-blocking position. The solenoid arrangement and the motor, in particular the two position linear motor, can both be driven by the control unit and the power supply, respectively.

The blocking element can be moved linear or along a curvature, in particular a circular curvature. Preferred is an electronic blocking unit, whereby the blocking element of the blocking is a moveable pin, bolt, or latch. Such blocking elements are able to engage with a receiving unit, in particular in a recess, of a mechanical cylinder of a blocking device.

According to one embodiment of the present invention, the drive mechanism of the electronic blocking unit is self-latching when the blocking element is in the blocking position or in the non-blocking position. Such a drive mechanism blocks the movement of the blocking element in the blocking position and the non-blocking position in an easy way.

A preferred electronic blocking unit is characterized in that the blocking unit comprises an indicating unit for indication of the status of the electronic blocking unit. In other words, the indicating unit enables an indication whether the blocking element is in the blocking position or in the non-blocking position. The user of the locking system can easily see whether the door, the window or the like can be opened or not. The indicating unit is advantageously a visual indicating unit. This indicating unit can be a lighting element that can indicate the status of the electronic blocking unit. The lighting elements, for example LEDs, can show the status of the electronic blocking unit in an easy way. A blocking status can be indicated by a red light, wherein a non-blocking status can be indicated by no light or a green light. Alternatively, the indicating unit can be a mechanical unit. That means, the indication of the status of the electronic blocking unit can be indicated by a mechanically moved element.

According to a further preferred development of the present invention an electronic blocking unit can be characterised in that the control unit is constructed in such a way that it is manipulation protected. For example, the control unit can be accessed only by a special authorization. According to a preferred development of the invention an electronic blocking unit may be provided, wherein the electronic blocking unit comprises an antenna for receiving signals, in particular transponder signals, wherein the antenna is connected to the control unit for transmitting the received signals to the control unit. The antenna can be fixed at the locking device, in particular on the surface of the cylinder of the locking device. The antenna enables that the blocking element can be moved only by a special authorization which can be sent via a signal to the antenna. For example, a transponder chip can be placed into or at the key, by which the cylinder can be moved manually. If the key with the transponder gets close to the antenna of the electronic blocking unit a signal is transmitted from the transponder to the antenna and is further transmitted from the antenna to the control unit. In the control unit the signal, which can be an authorization signal, is further processed. The control unit can decide whether the blocking element is moved or not. Therefore, an electronic blocking unit is preferred is characterized in that the control unit comprises a processor unit constructed such that it can control the operation of the drive mechanism in dependency of determinable parameters. These determinable parameters can be access authorization parameters, time parameters and/or date parameters. Further, the control unit and the processor unit, respectively, can comprise a memory device that allows storing of certain determinable parameters. After receiving a transponder signal the processor unit can compare the data of the signal with stored data. If the received transponder signal and the data of the transponder signal, respectively, correspond with stored parameters, the control unit can control the drive mechanism, so that the blocking element is moved from a blocking position into the non-blocking position. Manifold parameters can be stored in the processor unit. It is possible that a memory clock and calendar functions can be used to achieve different access scenarios for the door, the window or the like. In other words the control unit can control the opening and closing of the door, the window or the like, by controlling the drive mechanism and therefore the blocking element. Because of the determinable parameters the control unit can hold the blocking element in the blocking position in night times.

The power supply of the electronic blocking unit can be an external source, like a power grid. Advantageously, the power supply of the electronic blocking unit is a battery that can be fixed at the blocking unit, in particular inside a housing of the blocking unit. Preferred is a battery with a power saving mode. This saving mode can be combined with a very quick wake-up feature so that the battery can be activated very quickly, when the locking device is used. In other cases the battery can be conserved by the saving mode.

Further, an electronic blocking unit is preferred, which is characterised in that the electronic blocking unit comprises emergency power connectors. This enables that the locking system, in particular the electronic blocking unit of the locking system, can be operated in case that the battery is empty.

Advantageously, the electronic blocking unit is constructed such that the electronic blocking unit can be inserted into the housing of the manually operateable locking device. For example, the electronic blocking unit can replace an upper or lower cover lid of the housing of the locking device. That means that the electronic blocking unit can be inserted into the housing of the locking device at the same position as the cover lid or space. The electronic blocking unit, in particular housing of the electronic blocking unit, can be fixed to the housing of the manually operateable locking device in the same way like the cover lid is fixed to the housing of the locking device. In other words, the electronic blocking unit is a replacement unit, which can be added to an ordinary operateable locking device instead of a cover lid, if necessary.

According to one embodiment of the present invention the object of the invention is solved by a locking system of a door, a window or the like, comprising a manually operateable locking device and an electronic blocking unit as described before according to the first aspect of the invention. Such a locking system makes use of the same advantages already described above with respect to the inventive electronic blocking unit. Such a locking system can be used in different ways. If a very simple solution for the locking of a door, a window or the like is desired, a locking system can be offered only with a manually operateable locking device. If a manifold and more complex locking system is desired, the electronic blocking unit can be added to the manually operateable locking device, so that the locking system can be operated manually and electromechanically.

According to a preferred development of the invention the locking system can be a mortise lock.

Further, a locking system is preferred, wherein the locking device comprises a mechanical cylinder with a receiving unit, in particular a nut, a recess or the like, for receiving the blocking element of the electronic blocking unit. in other words, for the blocking purpose the blocking element, which can be a bolt, a latch or a pin, can be dipped into the receiving unit of the cylinder, in particular of a rotor of the cylinder. In the blocking position the blocking element engages with the receiving unit, wherein in the non-blocking position the blocking element is released from the receiving unit of the mechanical cylinder of the locking device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described with respect to the accompanying drawings. In the drawings:

FIG. 1 is a sectional view from a side of a locking system, which is constructed according to one embodiment of the invention;

FIG. 2 is a sectional view from the side through an electronic blocking unit fixed at the cylinder of a locking system;

FIG. 3 is a front view of a cylinder of a locking system;

FIG. 4 is a sectional view through the drive mechanism of an electronic blocking unit and through a rotor of the cylinder of a locking device of a locking system;

FIG. 5 is a front view of a cylinder of a locking system; and

FIG. 6 is two keys with transponder units.

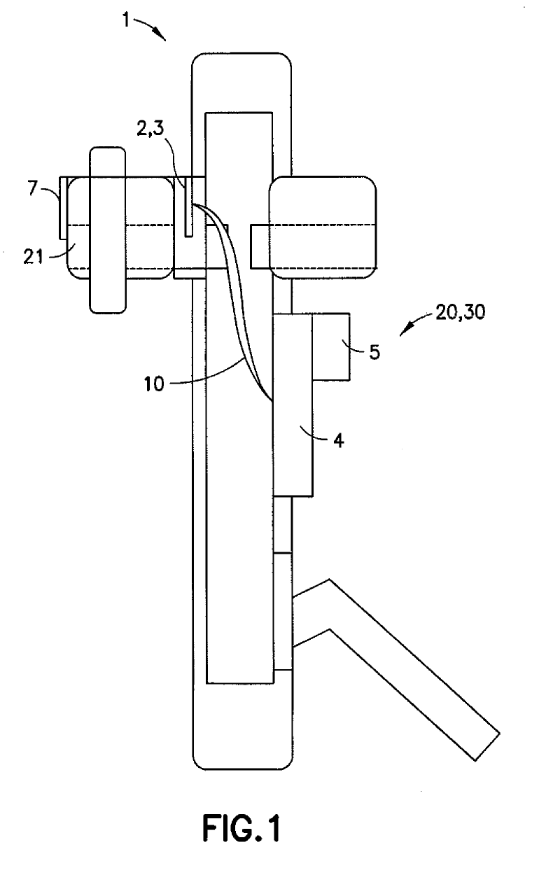

Elements of the same functions and mode of operation are provided with the same reference numbers in the FIGS. 1 to 6.

### DETAILED DESCRIPTION OF THE PRESENTLY PREFERRED EMBODIMENTS

FIG. 1 shows schematically in a sectional view from the side a locking system 30 comprising a manually operateable locking device 20 and an electronic blocking unit 1. The electronic blocking unit 1 is fixed to the manually operateable locking device 20. The electronic blocking unit 1 comprises a blocking element 2, which is moveable between a blocking position and a non-blocking position. Further, the electronic blocking unit 1 comprises a drive mechanism 3, in particular a linear motor or a solenoid arrangement, for moving the blocking element 2 from the blocking position into the non-blocking position and vice versa. Further, a control unit 4 is part of the electronic blocking unit 1. The control unit 4 and the drive mechanism 3 and therefore the blocking element 2 are connected by data connection 10. The blocking element 2 is arranged next to the cylinder 21 of the manually operateable locking device 20 for engaging with the cylinder, in particular with a rotor of the cylinder, in the blocking position of the blocking element 2. That means, that blocking element 2 is constructed in such a way that in the blocking position it blocks the opening of a door, a window or the like at which the locking system 30 is fixed to. In the non-blocking position the blocking element 2 does not block the opening of the door, the window or the like. Also provided is power supply 5.

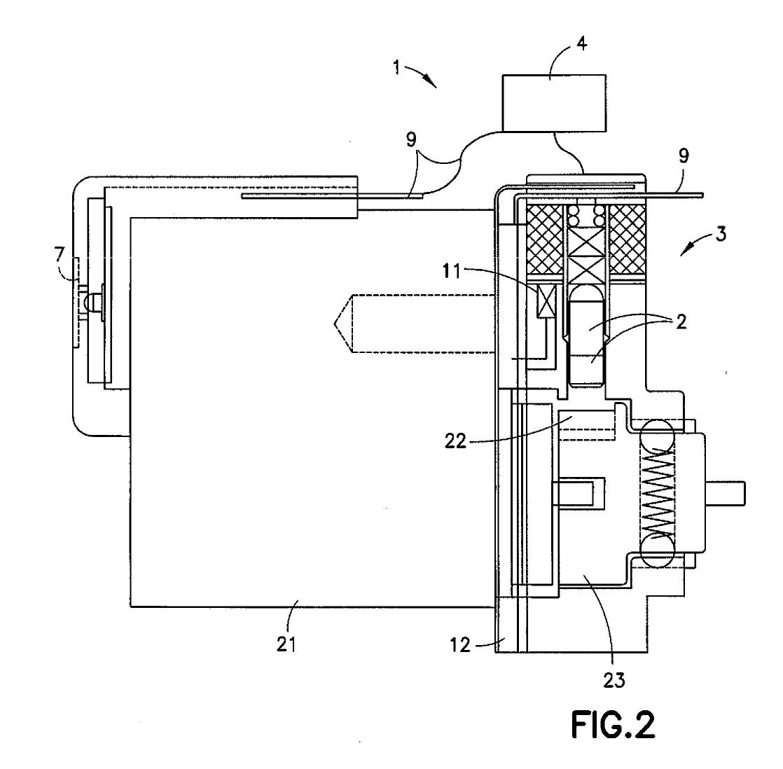

FIG. 2 shows schematically a sectional view through a cylinder 21 of a locking system 30 and through an electronic blocking unit 1 arranged at the cylinder 21 of the locking device 20 of the locking system 30. The electronic blocking unit 1 comprises a control unit 4 for operating the drive mechanism 3, here a solenoid arrangement. The control unit 4 is further connected by a flexible cable 9 to an antenna 7, in particular a MIFARE-antenna of an RFID-antenna. The antenna 7 is able to receive external signals, in particular a signal from a transponder, and to transmit this received signal to the control unit 4. The control unit 4 can check the transmitted signal and data, respectively, and can control the drive mechanism 3 based on the evaluation of the received data. For example, the received signal can comprise an authorization parameter for releasing the blocking element 2 from the blocking position. After getting a signal from the control unit 4, the drive mechanism 3 can move the blocking element 2 between the blocking position and the non-blocking position. The drive mechanism 3 moves the blocking element 2, here in form of a pin, into the receiving unit 22 in the cylinder 21 and rotor 23, respectively. That means, in the blocking position the tip of the blocking element 2 is dipped into the receiving unit 22 of the rotor 23 of the cylinder 21. The receiving unit 22 is advantageously a recess or a nut in the rotor 23 of the cylinder 21. In FIG. 2 the blocking element 2 is in the non-blocking position. Further, a circuit board 12 is shown which enables the electric contacting of the elements of the electronic blocking unit 1 with each other. One of the flexible cables 9 can be used as a power supply cable. In FIG. 2 the power supply, in particular a battery, is not shown.

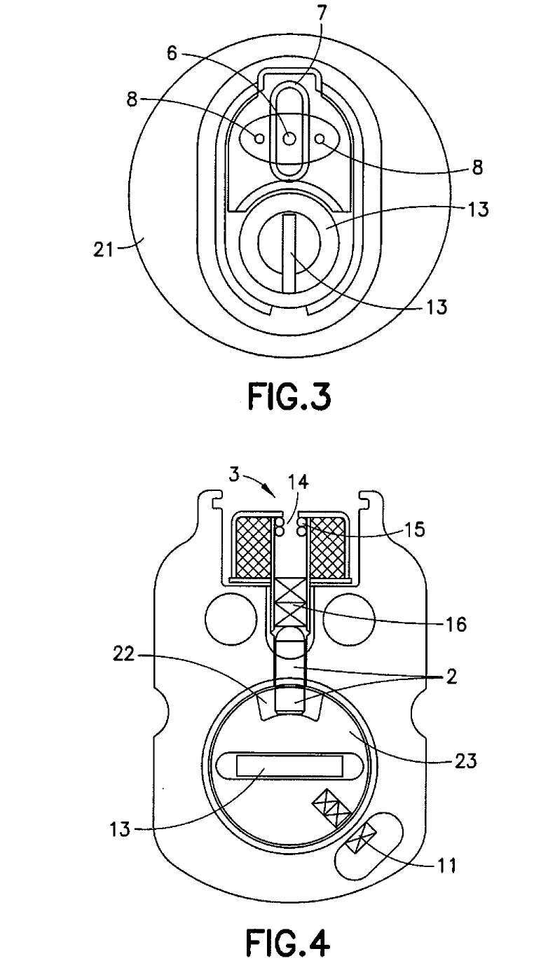

FIG. 3 shows schematically in a front view a cylinder 21 of a locking system 30. At the front of the cylinder 21 an antenna 7 is fixed, whereby the antenna 7 is placed above the inserting opening 13 for keys. Such keys 40 are shown in FIG. 6. The inserting opening 13 is arranged inside the rotor 23 of the mechanical cylinder 21. Further, an indicating unit 6 is arranged at the front side of the cylinder 21 for indicating the status of the electronic blocking unit 1 and therefore of the blocking or non-blocking of the locking system 30. Further, emergency power connectors 8 are arranged at the front side of the cylinder 21 to ensure a power supply to the locking system 30 in particular to the electronic blocking unit 1, in case of a break down of the normal power supply of the electronic blocking unit 1. The power supply 5, in particular a battery, is shown in FIG. 1.

FIG. 4 shows schematically a sectional view of the drive mechanism 3 of a blocking unit 1 and a rotor 23 of a cylinder 21 of the locking system 30. in this FIG. 4 the blocking element 2 is plugged in the receiving unit 22 of the rotor 23. That means, in FIG. 4 a motion of the rotor 23 is blocked by the blocking element 2 of the electronic blocking unit 1. The drive mechanism 3 can comprise an air escape aperture 14, a magnetic balance device 15 and a self-centering tip 16. The blocking element 2 is coupled to the self-centering tip 16 and can be moved by a movement of the self-centering tip 16. In the middle of the rotor 23 an inserted opening 13 for keys 40 is arranged. Further, a sensor 11 is arranged next to the rotor 23 for detecting the status of the rotor 23.

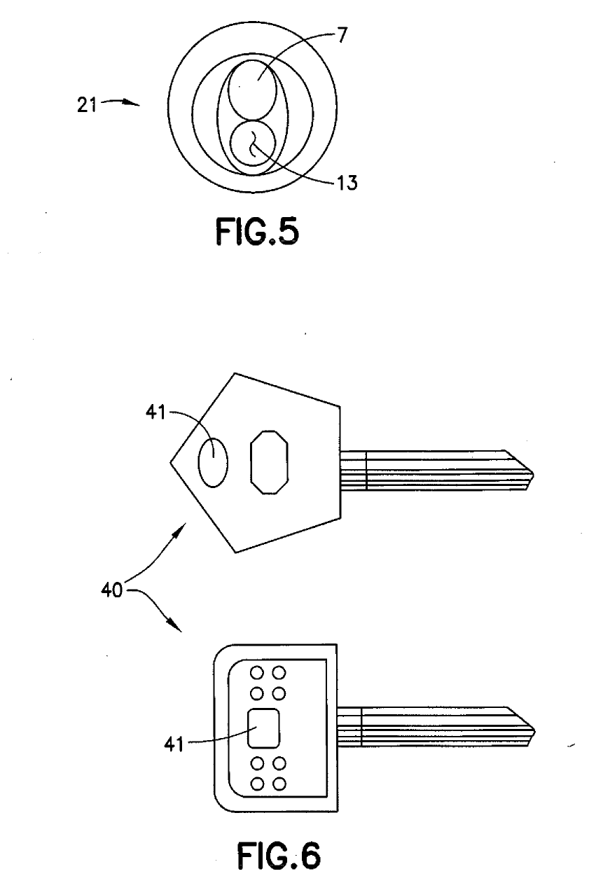

FIG. 5 shows once again a cylinder 21 of a locking system 30 schematically in a front view. Above the inserting opening 13 for keys 40 the antenna 7 is arranged.

FIG. 6 shows two keys 40 with chips 41, in particular transponder chips, arranged at the key head. The transponder chip 41 can be arranged directly into the key head or in a chip holder which is fixed at the key head. When the key is enclosed to the cylinder 21 of the locking device 20 and therefore to the antenna 7 of the electronic blocking unit 1 a transponder signal is sent to the antenna 7 and from there transmitted the control unit 4 of the electronic blocking unit 1. Such specific key 40 can therefore send an authorization to the locking system 30 to enable the blocking or non-blocking of the locking system 30 and therefore, of the door, the window or the like.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. An electronic blocking unit for adding to a manually operateable locking device for one of a door and a window configured as a mortise lock to provide a manually and electromechanically operateable locking system, the electronic blocking unit comprising:
a blocking element that is moveable between a blocking position and a non-blocking position such that in the blocking position it blocks the opening of the door or the window and in the non-blocking position it does not block the opening of the door or the window;
a drive mechanism configured to move the blocking element;
a control unit configured to operating the drive mechanism; and
a power supply for configured to operating the control unit and the drive mechanism.

2. The electronic blocking unit according to claim 1, wherein the blocking element blocks movement of a mechanical cylinder of the locking device.

3. The electronic blocking unit according to claim 1, wherein the drive mechanism is a one of a motor and a solenoid arrangement.

4. The electronic blocking unit according to claim 1, wherein the blocking element is one of a moveable pin, a bolt, and a latch.

5. The electronic blocking unit according to claim 1, wherein the drive mechanism is self-latching.

6. The electronic blocking unit according to claim 1, further comprising an indicating unit for indicating a status of the electronic blocking unit.

7. The electronic blocking unit according to claim 1, wherein the control unit is manipulation protected.

8. The electronic blocking unit according to claim 1, further comprising an antenna configured to receive signals, the antenna is connected to the control unit for transmitting the received signals to the control unit.

9. The electronic blocking unit according to claim 1, wherein the control unit comprises a processor unit constructed such that it controls operation of the drive mechanism based at least in part on determinable parameters.

10. The electronic blocking unit according to claim 9, wherein the determinable parameters are one or more of access authorization parameters, time parameters, and date parameters.

11. The electronic blocking unit according to claim 1, wherein the power supply is a battery with a power saving mode.

12. The electronic blocking unit according to claim 8, wherein the antenna is one of a MIFARE antenna and an RFID antenna.

13. The electronic blocking unit according to claim 1, wherein the electronic blocking unit further comprises emergency power connectors.

14. The electronic blocking unit according to claim 1, wherein the electronic blocking unit is insertable into a housing of the manually operateable locking device.

15. A locking system of an aperture comprising:
a manually operateable locking device; and
an electronic blocking unit comprising:
a blocking element that is moveable between a blocking position and a non-blocking position such that in the blocking position it blocks the aperture and in the non-blocking position it does not block the aperture;
a drive mechanism configured to move the blocking element;
a control unit configured to operating the drive mechanism; and
a power supply for configured to operating the control unit and the drive mechanism.

16. The locking system according to claim 15, wherein the locking device is a mortise lock.

17. The locking system according to claim 15, wherein the locking device comprises a mechanical cylinder with a receiving unit configured to receive the blocking element of the electronic blocking unit.

18. The electronic blocking unit according to claim 6, wherein the indicating unit is a lighting unit.
